(19) United States
(12) Patent Application Publication
(10) Pub. No.: US 2018/0306564 A1
(43) Pub. Date: Oct. 25, 2018

(54) METHOD AND SYSTEM FOR REMOTE MAGNETO-INDUCTIVE DETONATION

(71) Applicant: Ultra Electronics Maritime Systems Inc., Dartmouth (CA)

(72) Inventors: Donald DINN, Dartmouth (CA); Evan LOCKE, Porters Lake (CA)

(73) Assignee: Ultra Electronics Maritime Systems Inc., Dartmouth (CA)

(21) Appl. No.: 15/491,278

(22) Filed: Apr. 19, 2017

(51) Int. Cl. F42C 11/06; H04B 5/00

(52) U.S. Cl. CPC F42C 11/06; H04B 5/0075

(57) ABSTRACT

Method and systems of controlling detonation of a plurality of explosive charges. A controller has a magneto-inductive transmitter to transmit a magneto-inductive signal to a plurality of detonators, each having a receiver to receive the magneto-inductive signal and a respective firing delay time. The method includes, at each of the plurality of detonators, receiving, via the magneto-inductive signal from the magneto-inductive transmitter, a time sync signal; synchronizing a local clock in the detonator based on the time sync signal; receiving, via the magneto-inductive signal from the magneto-inductive transmitter, a firing code; waiting the respective firing delay time from receipt of the firing code, wherein the waiting is clocked by the local clock; and after expiry of the respective firing delay time, triggering a respective explosive associated with the detonator.

### FIELD

The present application generally relates to detonation systems and, in particular, to a system and method that uses magneto-inductive signals to control detonation.

### BACKGROUND

Controlled detonation of explosives occurs in a number of applications, including mining and military settings. In many cases, the detonation involves tens to hundreds of explosives that are planned to be set off in a precisely timed sequence. Historically, controlled detonation of multiple explosives relied upon manual wiring of all explosives to a blast controller that an operator would use to generate firing signals to the individual explosives along their respective wired connections. This is complex, expensive and time-consuming to set up and features multiple potential failure points as wires may be damaged or disconnected.

To address this issue, there have been attempts to trigger explosives using RF signaling. This meets with reliability and safety concerns since RF is subject to reflection, multi-path, and attenuation problems, particularly in harsh environments, such as those typically encountered in marine and mining applications. A concern in military applications is that RF is subject to jamming and interference, whether accidental or intentional.

### BRIEF DESCRIPTION OF THE DRAWINGS

Reference will now be made, by way of example, to the accompanying drawings which show example embodiments of the present application, and in which:

FIG. 1 diagrammatically shows an example of a magneto-inductive wireless detonation system.

FIG. 2 shows, in block diagram form, an example of a remote controller and a detonator in a magneto-inductive detonation system.

FIG. 3 shows, in flowchart form, an example process for triggering an explosive using magneto-inductive communications.

FIG. 4 shows, in flowchart form, an example process for detonating an explosive using magneto-inductive communications.

FIG. 5 shows an example command sequence for detonating an explosive using magneto-inductive communications.

FIG. 6 shows another example command sequence for detonating an explosive using magneto-inductive communications.

Similar reference numerals may have been used in different figures to denote similar components.

### DESCRIPTION OF EXAMPLE EMBODIMENTS

In a first aspect, the present application describes a detonation system for controlling detonation of a plurality of explosive charges. The system includes a controller, including a magneto-inductive transmitter and antenna to transmit magneto-inductive signals, and including a modulator to encode the magneto-inductive signal with a time sync signal and a firing code; and a plurality of detonators. Each detonator includes a local clock, a receive antenna, a receiver to detect magneto-inductive signals induced in the receive antenna and including a demodulator to obtain the time sync signal and the firing code from detected magneto-inductive signals and to provide the time sync signal to the local clock, wherein the local clock is to sync its time based on the time sync signal, a delay circuit having a firing delay time, wherein the delay circuit is to be initiated by the firing code and clocked by the local clock, and wherein the delay circuit is to generate a fire signal on expiry of the firing delay time, and a firing circuit to trigger an explosive, the circuit being coupled to the delay circuit to receive the fire signal.

In another aspect, the present application discloses a method of controlling detonation of a plurality of explosive charges using a detonation system that includes a controller having a magneto-inductive transmitter to transmit a magneto-inductive signal, and a plurality of detonators, each detonator having a receiver to receive the magneto-inductive signal and a respective firing delay time. The method includes, at each of the plurality of detonators, receiving, via the magneto-inductive signal from the magneto-inductive transmitter, a time sync signal; synchronizing a local clock in the detonator based on the time sync signal; receiving, via the magneto-inductive signal from the magneto-inductive transmitter, a firing code; waiting the respective firing delay time from receipt of the firing code, wherein the waiting is clocked by the local clock; and after expiry of the respective firing delay time, triggering a respective explosive associated with the detonator.

In yet a further aspect, the present application describes non-transitory computer-readable media storing computer-executable program instructions which, when executed, configured a processor to perform the described methods.

Other aspects and features of the present application will be understood by those of ordinary skill in the art from a review of the following description of examples in conjunction with the accompanying figures.

The present application uses the term “magneto-inductive” (MI) to refer to a class of communications that employ large AC low-frequency magnetic fields. These fields are established using loop antennas at a low enough frequency that they penetrate media that normally attenuates typical RF communications to render them unreliable, such as earth, rock, water and the like. These ‘quasi-static’ MI fields have extremely small electric fields associated with them and typically use frequencies near or below 10 kHz and, at times, between 500 and 3000 Hz.

In the present application, the term “and/or” is intended to cover all possible combination and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

There are many applications that call for the controlled detonation of explosives with precise timing. In particular, demolition or mining typically involves the controlled timed detonation of tens to hundreds of explosives.

Historically, controlled detonation of multiple explosives relied upon manual wiring of all explosives to a blast controller that an operator would use for generation of triggering signals to the individual explosives. This is complex, expensive and time-consuming to set up. It results in multiple failure points as wires may be damaged or disconnected.

To address this issue, there have been attempts to trigger explosives using RF signaling. This meets with reliability and safety concerns since RF is subject to reflection, multi-path, and attenuation problems, particularly in harsh environments, such as those typically encountered in marine and mining applications. A concern in military applications is that RF is subject to jamming and interference, whether accidental or intentional.

In one aspect, the present application proposes to use MI communications to control detonation of explosives. The use of MI technology addresses concerns with reflection, attenuation, interference and jamming that would otherwise pose problems for RF-based systems. In one aspect, the present application proposes a plurality of untethered detonators each capable of detecting and demodulating MI communications from a remote controller having an MI transmitter.

Each detonator may have its own firing delay, whether pre-set/programmed within the detonator or set wirelessly by the controller prior to a firing command. However, this does not necessarily lead to well-controlled blast sequencing. Accordingly, in accordance with another aspect of the present application, the plurality of wireless MI detonators use a time synchronization process to sync to a common time using a time sync signal from the remote controller.

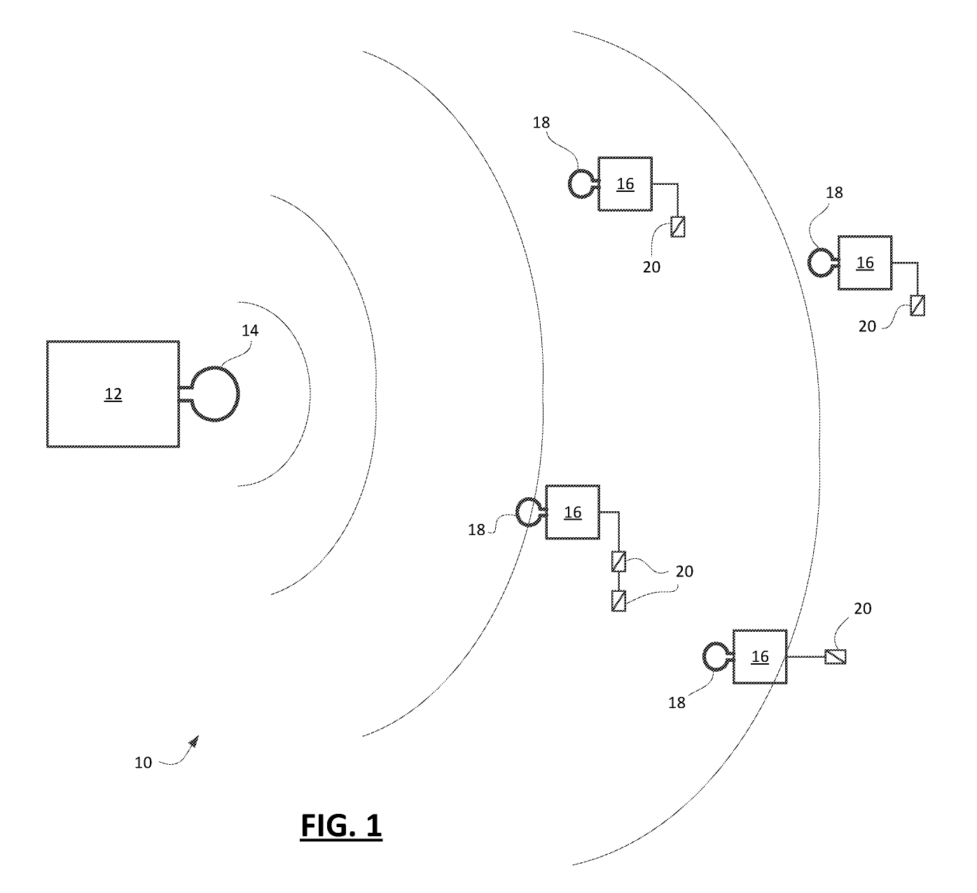

Reference is now made to FIG. 1, which shows, diagrammatically, an example system 10 for magneto-inductive detonation of explosives. A remote controller 12 includes a magneto-inductive antenna 14 and establishes a quasi-static magnetic field. The magneto-inductive antenna 14 may be a loop antenna.

A plurality of detonators 16 are deployed in the application environment, such as a mining site or blast site. Each detonator 16 includes a receive antenna 18. The receive antennas 18 may be loop antennas. Each detonator 16 detects the quasi-magnetic field through current induced in the respective receive antenna 18. The detonators 16 are connected to one or more explosives 20. In some cases, each detonator 16 may trigger a single explosive 20. In some cases, one or more of the detonators 16 may trigger more than one explosive 20, such as a line charge.

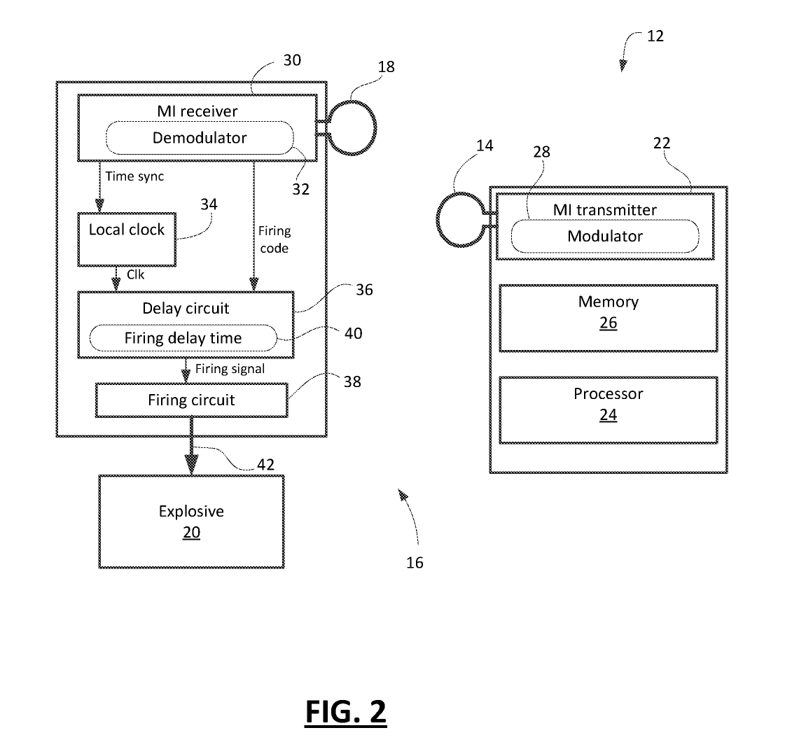

Reference is now made to FIG. 2, which shows, in block diagram form, a simplified example of the system 10 for magneto-inductive detonation of explosives, including the remote controller 12 and one of the detonators 16. The remote controller 12 includes magneto-inductive antenna 14 coupled to a magneto-inductive transmitter 22. The magneto-inductive transmitter 22 generates magneto-inductive signals to drive the antenna 14 and establish the MI field. The magneto-inductive transmitter 22 may operate under control of a processor 24. The remote controller 12 may further include a memory 26 that stores program instructions executable by the processor 24 and data and variables relevant to implementation of the detonation process, as will be described in greater detail below.

The MI transmitter 22 may include a modulator 28 to encode data into the MI signals broadcast by the remote controller 12 so as to communicate commands and instructions to the detonators 16, such as timing synchronization signals and firing codes. In some embodiments, the detonators 16 may be addressable, and the modulator 28 may, in the detonation process, send addresses to detonators 16 to signal that those particular detonators 16 are to monitor for and respond to a firing code. In some embodiments, the detonators 16 may be programmable, for example the firing delay time may be remotely configurable. In this example, the modulator 28 may encode the MI signals with address information to identify a particular detonator 16 and a firing delay time that the particular detonator 16 is to store and implement.

The modulation used by the modulator 28 may be any suitable modulation scheme for MI signals. In some embodiments, the modulation is amplitude-shift keying, such as on-off keying. Other schemes may be suitable for other embodiments. In some embodiments, the modulator 28 may encrypt communications. The encryption may rely on shared key material or other encryption schemes suitable to a specific implementation.

The example detonator 16 includes the receive antenna 18 coupled to an MI receiver 30, which may include a demodulator 32, to recover data and information transmitted by the remote controller 12. The detonator 16 may further include a local clock 34, a delay circuit 36 and a firing circuit 38.

The local clock 34 is a high precision local clock that is frequency accurate to within a micro second. It outputs a clock signal, CLK, which may be used to clock the delay circuit 36. The clock signal may be a one pulse per second (PPS) signal in some embodiments. In some cases, it may have a different frequency. For example, the clock signal may be every tenth of a second, every hundredth of a second, or every millisecond. Yet other clock intervals may be used in other cases.

The delay circuit 36 includes a firing delay time 40. The firing delay time 40 may be pre-set in the detonator 16 prior to deployment in the blast area. In some embodiments, the firing delay time 40 may be programmable through software settings. In some implementations, the firing delay time 40 may be mechanically set through actuators. In yet other implementations, the firing delay time 40 may be stored in memory in the delay circuit 36 or elsewhere in the detonator 16, and may be adjustable through command signals from the remote controller 12. The firing delay time 40 may be stored in the format of seconds of delay from receiving of a firing code before the explosive 20 is to be detonated. Receipt of a firing code (and validation of the firing code, if applicable) triggers the delay circuit 36 to begin counting down the firing delay time 40. Once the firing delay time 40 expires, the delay circuit 36 sends a fire signal to the firing circuit 38.

The firing circuit 38 generates a trigger signal 42 to trigger detonation of the explosive. The design of the firing circuit 38 and the nature of the trigger signal 42 may depend on the type of explosive 20 to be detonated. Those ordinarily skilled in the art of demolition and explosives will be familiar with the range of firing circuits that may be suitable for particular embodiments.

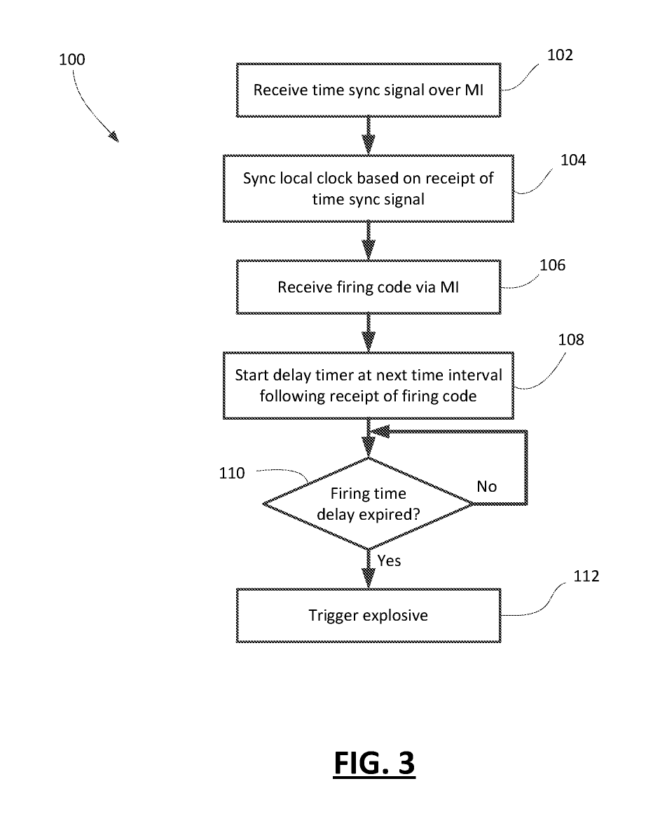

Reference is now also made to FIG. 3, which shows, in flowchart form, one example process 100 for triggering an explosive using magneto-inductive communications. The process 100 is carried out by each of a plurality of untethered detonators 16.

The process 100 includes an operation 102 of receiving a time synchronization signal via MI communication from an MI transmitter, such as the remote controller 12. The demodulator within the detonator decodes a time synchronization code or sequence from the MI signal induced in the detonator's antenna. This code may, in some embodiments, be a 64-bit code. In some embodiments, the code may be repeated a number of times, for example 8 times as a concatenated code. In some embodiments the code may be shorter or longer than 64 bits, for example a single 512-bit code. The purpose of the time synchronization signal is to cause each of the detonators 16 to lock to a common time base, i.e. to sync their local clocks to a common start point. Over time as the detonators 16 are stored or sit in the field, they may lose synchronicity, despite the fact that their internal local clocks are high precision. Over enough time, the small deviations in precision accumulate to cause sufficient drift such that the one-second intervals of the various clocks in the various detonators 16 are misaligned. The time synchronization signal from the controller causes them to realign their time intervals to a common start point. The time synchronization code may be known to each of the detonators 16 in advance and may be stored in memory in the detonators 16.

In operation 104, each detonator 16 having detected the time synchronization code, the detonators each zero their clocks based on receipt of the time synchronization code. There are various implementations possible. For example, the detonators 16 may be configured to align the clocks with the falling edge of the last bit of the code. Other implementations for aligning the local clocks based on receipt of the time synchronization signal will be appreciated by those ordinarily skilled in the art.

In operation 106, the detonators 16 receive a firing code via MI communication from the remote controller 12. The firing code may be a predetermined code stored in the detonators in advance. Receipt of the firing code may include performing various verification or authentication operations to validate the firing code as legitimate.

Once the firing code has been received, and authenticated in some cases, the detonators 16 each start their delay circuit countdowns to count their respective firing delay times, as indicated by operation 108. The delay circuits are clocked by the local clocks which, having been aligned, substantially simultaneously begin their delay countdowns.

In some embodiments, there may be slight differences in when the various detectors 16 detect receipt of the firing code. The differences may be a few to tens of milliseconds in some cases. Nevertheless, to ensure timing accuracy in the triggering of the explosives, instead of initiating the delay countdown when the firing code is received, the detonators 16 wait until a predetermined clock interval occurs following receipt of the firing code, and the delay countdown is then initiated. In some embodiments, the clock interval is the next one-second interval. Accordingly, when a detonator 16 receives a firing code it waits until the subsequent 1-second clock interval occurs and then initiates the delay countdown in the delay circuit. In this manner, all of the detonators 16, having had their clocks aligned to the same base, will initiate their delay countdowns at substantially the same time.

Operation 110 indicates the delay circuit countdown. Once the countdown has expired, i.e. the firing delay time is reached, then the detonator 16 triggers the explosives, as indicated by operation 112. As noted above, the specific circuitry for generating a trigger signal to detonate explosives may depend in part upon the type of explosive being detonated and may vary for different implementations.

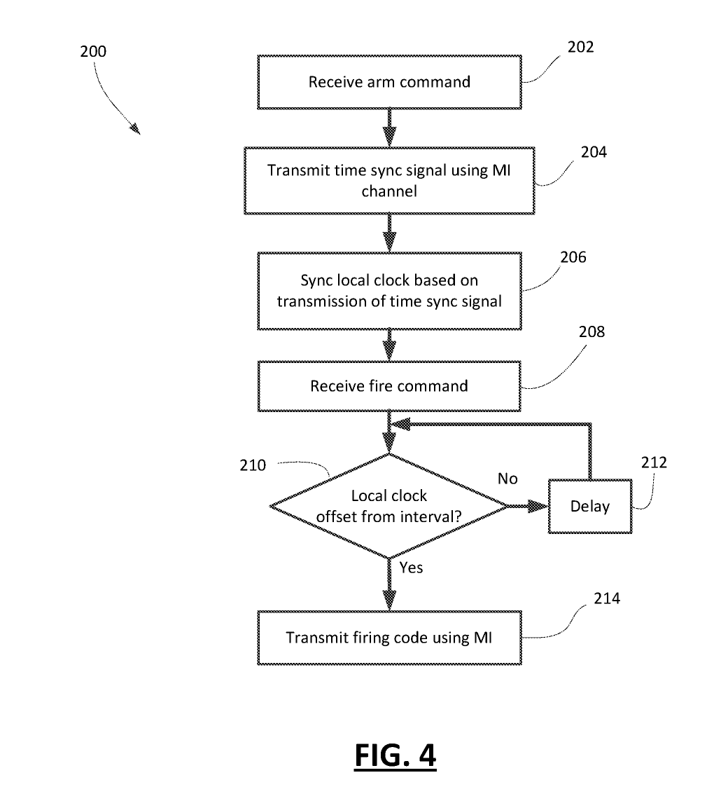

Reference will now also be made to FIG. 4, which shows, in flowchart form, one example process 200 for detonating an explosive using magneto-inductive communications. The process 200 may be implemented by a magneto-inductive transmitting device, such as the remote controller 12. The process 200 includes an operation 202 of receiving an arm command. The arm command is an input indicating that the remotely-deployed untethered detonators 16 should be put in a ready state to receive a detonation instruction. The arm command may be input via a keyboard, push key, toggle switch, electrical signal from an external device, or any other input mechanism.

In response to the arm command, the controller then, in operation 204, transmits a time synchronization signal over the MI channel. That is, the modulator encodes the MI signal with a time synchronization code or sequence. This code may, in some embodiments, be a 64-bit code. In some embodiments, the code may be repeated a number of times, for example 8 times as a concatenated code. In some embodiments the code may be another length, for example a single 512-bit code. As noted above, the purpose of the time synchronization signal is to cause each of the detonators to lock to a common time base, i.e. to sync their local clocks to a common start point. Over time as the detonators are stored or sit in the field, they may lose synchronicity, despite the fact that their internal local clock are high precision. Over enough time, the small deviations in precision accumulate to cause sufficient drift such that the one-second intervals of the various clocks in the various detonators are misaligned. The time synchronization signal from the controller cause them to realign their time intervals to a common start point.

The remote controller 12 synchronizes a local clock or counter of its own in operation 206 so that it is able to track the intervals being clocked in sync with each of the detonators 16. Because each of the detonators 16 will start their respective firing delay time countdowns at a common time, e.g. a 1-second mark, following receipt of the firing code, and because there may be slight delays or differences in when the detonators 16 receive and detect the firing code, the remote controller 12 may avoid sending the firing code at or near the time intervals. That is, if the firing code is sent just before a time interval, e.g. just before a 1-second mark, one detonator 16 may detect the firing code prior to the interval end point and start its countdown and another detonator 16 may detect the firing code just after the interval end point and start its countdown at the next interval end point, e.g. 1 second later. To avoid this potential problem, the remote controller 12 tracks the same time intervals using a local clock synced based on same time synchronization code, and avoids sending the firing code near an interval end point.

As indicated by operation 208, the remote controller 12 receives a fire command. The fire command may be received through detecting actuation of an input device, such as a push button, toggle switch, touch screen, or the like. It may alternatively be received as a detected signal from a remote device configured to relay commands to the remote controller 12.

In operation 210, the remote controller 12 assesses whether the local clock is sufficiently offset from a time interval end point. If the intervals are at the 1-second marks of the clock, then the remote controller 12 may assess whether the clock is too close to the 1-second mark. As an example, the remote controller 12 may be configured to determine that a time within 100 ms of the interval end point as too close. In other embodiments, the remote controller 12 may be configured to determine that a time is too close if it is within a predetermined window prior to the interval end point, but not after. That is, the remote controller 12 may avoid sending firing codes during some portion of the end of the time interval, e.g. within the last 250 ms of the interval in the case of a 1 sec clock interval. Other predetermined lengths of time within which the remote controller 12 will avoid sending the firing code may be applied in some embodiments. For example, if the clock interval is 0.1 seconds, then the modulator in the remote controller 12 may determine that 10 ms within the interval end is too close. Other intervals and windows may be used in particular implementations.

If the local clock at the remote controller 12 is within the predetermined window proximate the interval end point, then the remote controller 12 delays sending the firing code, as indicated by operation 212, until the time is outside that window. In one embodiment, the remote controller 12 may be configured to send the firing code at the midpoint of an interval, e.g. 0.5 seconds after the interval end point in the case of 1-second intervals. In operation 214, the firing code is transmitted using MI signaling.

As noted above, each detonator 16 includes a firing delay time which could range from 0 seconds up to any reasonably delay time for a particular application. The firing delay times may be preprogrammed into each detonator 16 prior to deployment. In another embodiment, the firing delay times may be programmed into each detonator 16 following deployment.

Each of the detonators may be addressable in some embodiments. In some embodiments a set of detonators may be jointly addressable using a group ID.

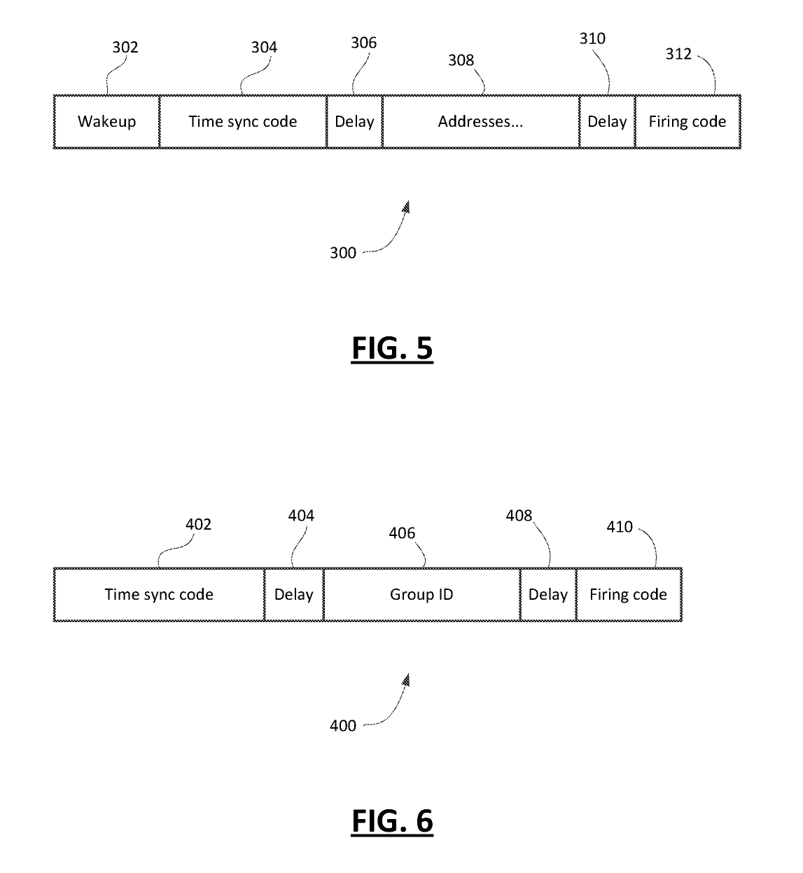

Reference is now made to FIG. 5, which diagrammatically shows one example command sequence 300 transmitted over MI by a controller, such as the remote controller 12. The example command sequence 300 may begin with a wakeup code 302 or sequence. This sequence may be a sequence of bits or trigger signals, or a continuous unmodulated MI signal, so as to give the detonators 16 time to power up from a sleep mode, if applicable, and prepare to receive commands.

The sequence 300 includes a time synchronization code 304 which in this embodiment is 512 bits long. The time synchronization code 304 is sufficiently long to enable all detonators 16 in range to lock onto the time synchronization code 304. The detonators 16 may be configured to sync their local clocks based on some specific point in the sequence, such as the falling or rising edge of the final bit of the time synchronization code 304, as an example. The time synchronization code 304 may then be followed by a short delay 306, which in this case is indicated as 1 ms.

The sequence 300 then, in this example embodiment, includes a sequence of addresses 308 for the detonators 16 that are to be triggered in this firing sequence. The addresses 308 may be preceded by an indication of the number of addresses included in the sequence, in some cases. Each detonator 16 awoken by the wakeup code 302 then determines whether their respective address is included in the addresses 308 and, if not, may go back to sleep and ignore the rest of the sequence 300.

After alerting each of the detonators 16 by address, then there is a second delay 310. The second delay 310 may be due to the remote controller 12 awaiting a firing command in some cases. In some cases, it may be the remote controller 12 waiting for the local clock to become misaligned from the end point of an interval.

The sequence 300 then includes the firing code, which in this example embodiment is shown as being 64 bits. Codes of other lengths may be used in other embodiments.

FIG. 6 shows another example embodiment of a command sequence 400 transmitted over MI by a controller. In this example, the sequence 400 does not feature a distinct wakeup code, but instead begins with the time synchronization code 402. The time synchronization code 402 may be sufficiently long to enable each detonator 16 to wake up and lock onto the time synchronization code 402. In some embodiments, the detonators 16 may not have a sleep mode that necessitates a wake up period.

After the time synchronization code 402, the sequence 400 may have a brief delay 404, following which it includes a group ID 406. The detonators 16 receive the group ID 406 and determined whether it matches a group ID stored locally in their respective memories. If not, then they may ignore the remainder of the sequence 400 and, if applicable, enter a sleep state. If the group ID 406 matches, then they may listen for a firing code.

A second delay 408 may follow the group ID 406, following which a firing code 410 is sent, causing the detonators to initiate their firing processes, as described above.

It will be appreciated that the command sequence may vary in different embodiments. For example, in some embodiments, there may be no addresses or group IDs. In some example implementations, the addresses and/or group ID may be sent prior to time synchronization code. In yet other implementations, additional codes may be sent for authentication/authorization purposes.

Certain adaptations and modifications of the described embodiments can be made. Therefore, the above discussed embodiments are considered to be illustrative and not restrictive.

What is claimed is:

1. A detonation system for controlling detonation of a plurality of explosive charges, the system including:
a controller, including a magneto-inductive transmitter and antenna to transmit magneto-inductive signals, and including a modulator to encode the magneto-inductive signal with a time sync signal and a firing code; and
a plurality of detonators, each detonator including
a local clock,
a receive antenna,
a receiver to detect magneto-inductive signals induced in the receive antenna and including a demodulator to obtain the time sync signal and the firing code from detected magneto-inductive signals and to provide the time sync signal to the local clock, wherein the local clock is to sync its time based on the time sync signal,
a delay circuit having a firing delay time, wherein the delay circuit is to be initiated by the firing code and clocked by the local clock, and wherein the delay circuit is to generate a fire signal on expiry of the firing delay time, and
a firing circuit to trigger an explosive, the circuit being coupled to the delay circuit to receive the fire signal.

2. The system claimed in claim 1, wherein the time sync signal comprises a pattern of bits.

3. The system claimed in claim 2, wherein the time sync signal comprises the pattern of bits repeated a plurality of times.

4. The system claimed in claim 3, wherein the local clock is to synchronize based on a falling edge of the last bit of the time sync signal.

5. The system claimed in claim 1, wherein the modulator in the controller encodes the magneto-inductive signal with a command sequence, and wherein the command sequence includes a wake-up sequence, the time sync signal, and the firing code.

6. The system claimed in claim 5, wherein the command sequence includes one or more addresses after the time sync signal and before the firing code, wherein each detonator has a respective address, and wherein the receiver in each detonator is to compare said one or more addresses to its respective address to determine whether the command sequence is addressed to it.

7. The system claimed in claim 6, wherein each detonator is to ignore the firing code and enter a sleep mode if its receiver determines that its address is not present in the command sequence.

8. The system claimed in claim 6, wherein said one or more addresses comprises a group ID shared by two or more detonators.

9. The system claimed in claim 1, wherein the controller further includes a clock to be synced to the local clocks of the plurality of detonators, and wherein the modulator is to determine that the clock is too close to a clock interval and, on that basis, delay sending the time sync signal until after the clock interval has passed.

10. The system claimed in claim 1, wherein the delay circuit is to initiate countdown of the firing delay time starting at a next clock interval of the local clock following detection of receipt of the firing code.

11. A method of controlling detonation of a plurality of explosive charges using a detonation system that includes a controller having a magneto-inductive transmitter to transmit a magneto-inductive signal, and a plurality of detonators, each detonator having a receiver to receive the magneto-inductive signal and a respective firing delay time, the method comprising:
at each of the plurality of detonators,
receiving, via the magneto-inductive signal from the magneto-inductive transmitter, a time sync signal;
synchronizing a local clock in the detonator based on the time sync signal;
receiving, via the magneto-inductive signal from the magneto-inductive transmitter, a firing code;
waiting the respective firing delay time from receipt of the firing code, wherein the waiting is clocked by the local clock; and
after expiry of the respective firing delay time, triggering a respective explosive associated with the detonator.

12. The method claimed in claim 11, wherein the time sync signal comprises a pattern of bits.

13. The method claimed in claim 12, wherein the time sync signal comprises the pattern of bits repeated a plurality of times.

14. The method claimed in claim 13, wherein synchronizing comprises synchronizing the local clock on a falling edge of the last bit of the time sync signal.

15. The method claimed in claim 11, further comprising the controller transmitting a command sequence via the magneto-inductive signal, wherein the command sequence includes a wake-up sequence, the time sync signal, and the firing code.

16. The method claimed in claim 15, wherein the command sequence includes one or more addresses after the time sync signal and before the firing code, wherein each detonator has a respective address, and wherein the method includes, at each detonator, comparing said one or more addresses to its respective address to determine whether the command sequence is addressed to it.

17. The method claimed in claim 16, wherein the method includes, at each detonator, ignoring the firing code and entering a sleep mode if that detonator determines that its address is not present in the command sequence.

18. The method claimed in claim 16, wherein said one or more addresses comprises a group ID shared by two or more detonators.

19. The method claimed in claim 11, wherein the controller further includes a clock to be synced to the local clocks of the plurality of detonators, and wherein the controller is to determine that its clock is too close to a clock interval and, on that basis, delay transmitting the time sync signal until after the clock interval has passed.

20. The method claimed in claim 11, wherein waiting the respective firing delay time comprises initiating countdown of the firing delay time starting at a next clock interval of the local clock following detection of receipt of the firing code.
